(19) United States
(12) Patent Application Publication
(10) Pub. No.: US 2012/0203843 A1
(43) Pub. Date: Aug. 9, 2012

(54) CONTACTING AN UNAVAILABLE USER THROUGH A PROXY USING INSTANT MESSAGING

(75) Inventors: Patrick Joseph O'Sullivan, Dublin (IE); Fred Reguillat, Dunboyne (IE); Jeffrey B. Sloyer, Fisherville, VA (US)

(73) Assignee: INTERNATIONAL BUSINESS MACHINES CORPORATION, Armonk, NY (US)

(21) Appl. No.: 13/020,141

(22) Filed: Feb. 3, 2011

(51) Int. Cl. G06F 15/16

(52) U.S. Cl. 709/206

(57) ABSTRACT

Described are systems and methods for locating a user at an event. According to various embodiments of the methods, authorization is received from the user to locate the user at the event. A radio frequency identification (RFID) tag of the user is tracked if the user is unavailable for instant messaging communication. An instant message communication directed to the user is received. A determination is made that a second user has a predetermined relationship with a sender of the instant message and determining that a communication device of the second user detects the RFID tag of the user. A communication is sent comprising a message for the user to the communication device of the second user.

### BACKGROUND

The invention relates generally to the field of communications, and more particularly, to a system and method for contacting a user through a proxy using instant messaging.

Instant messaging is an important means of communication within organizations of all types and sizes. Instant messaging enables a form of real-time direct text-based communication between two or more people using computers or other devices. Instant messaging is based on clients that make connections between specified known users who can be referred to as a “Contact List”, “Friend List” or “Buddy List”. Typically, users communicate using instant messaging if they are currently “logged on” and this makes it real-time communication. For example, IBM® Sametime® is a leading instant messaging application. Instant messaging allows effective and efficient communication, allowing immediate receipt of acknowledgment or reply.

Conventional instant messaging communications are tied to a user's personal device. Users can easily send and receive instant messages as long as the users have their personal devices with them. Often, trade show events are in large buildings and people are dispersed among these buildings; therefore, making it difficult for people to find each other.

### BRIEF SUMMARY

According to one embodiment of the invention, a computer-implemented method for locating a user at an event is provided. Authorization is received from the user to locate the user at the event. A radio frequency identification (RFID) tag of the user is tracked if the user is unavailable for instant messaging communication. An instant message communication directed to the user is received. A determination is made that a second user has a predetermined relationship with a sender of the instant message and determining that a communication device of the second user detects the RFID tag of the user. A communication is sent comprising a message for the user to the communication device of the second user.

According to another embodiment of the invention, a computer program product is provided for locating a user at an event. The computer program product comprises a computer readable storage medium having computer readable program code embodied therewith. The computer readable program code comprises computer readable program code configured to receive authorization from the user to locate the user at the event. The computer readable program code comprises computer readable program code configured to track an RFID tag of the user if the user is unavailable for instant messaging communication. The computer readable program code comprises computer readable program code configured to receive an instant message communication directed to the user. The computer readable program code comprises computer readable program code configured to determine that a second user has a predetermined relationship with a sender of the instant message and determining that a communication device of a second user detects the RFID tag of the user. The computer readable program code comprises computer readable program code configured to send a communication comprising a message for the user to the communication device of the second user.

According to another embodiment of the invention, a location and communication system for communication with an unavailable user at an event comprises a locating module, an RFID system, and an instant messaging module. The locating module receives an authorization from the user to locate the user at the event. The RFID system tracks an RFID tag of the user if the user is unavailable for instant messaging communication. The instant messaging module provides an instant messaging communication for a plurality of users through a communications network. The locating module is in communication with the RFID system and the instant messaging module. The locating module is configured to determine a second user having a predetermined relationship with a sender of an instant message. The RFID system is configured to determine that a communication device of the second user detects the RFID tag of the user and wherein the locating module is configured to send a communication intended for the user to the communication device of the second user in response to an instant message sent to the user.

According to another embodiment of the invention, a computer program product for locating a user is provided. The computer program product comprises a computer readable storage medium having computer readable program code embodied therewith. The computer readable program code comprises a computer readable program code configured to receive authorization from the user to locate the user. The computer readable program code comprises a computer readable program code configured to track an RFID tag of the user if the user is unavailable for instant messaging communication. The computer readable program code comprises a computer readable program code configured to receive an instant message communication directed to the user. The computer readable program code comprises a computer readable program code configured to determine that a second user has a predetermined relationship with a sender of the instant message and determining that a communication device of a second user detects the RFID tag of the user. The computer readable program code comprises a computer readable program code configured to send a communication comprising a message for the user to the communication device of the second user.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principals of the invention.

FIG. 1 is a network diagram illustrating an environment in which embodiments of the systems and methods according to the inventive concepts can be applied.

FIG. 2 is a block diagram of an embodiment of the location and communication system shown in FIG. 1.

FIGS. 3A and 3B are a flowchart of an embodiment of a method for contacting an unavailable user, who is at an event, through a proxy using instant messaging.

### DETAILED DESCRIPTION

In the following description, specific details are set forth although it should be appreciated by one of ordinary skill that the present invention can be practiced without at least some of the details. In some instances, known features or processes are not described in detail so as not to obscure the present invention.

In brief overview, the present invention features a system and method for contacting an unavailable user, who is at an event, through a proxy using instant messaging. A sending user, located at a first event location, sends an instant message to a receiving user's device. The receiving user's device is at a second event location. A determination is made as to whether the receiving user's instant messaging (IM) client is in away mode and as to whether the receiving user has authorized the use of event location tracking. If the receiving user's IM client is in away mode and the receiving user has authorized tracking at this event, then a tracking system locates the receiving user. A locating module identifies a social network of the sending user. A determination is made as to whether the instant message from the sending user is an urgent instant message. If the IM is urgent, the locating module identifies one or more proxy devices that are also at this event. The proxy devices are the one or more devices, selected from a group of devices belonging to users in the sending user's social network, which are proximate to the receiving user. The locating module sends an instant message to the one or more proxy devices; the message requests that the proxy users inform the receiving user, that the sending user has an urgent message for the receiving user.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

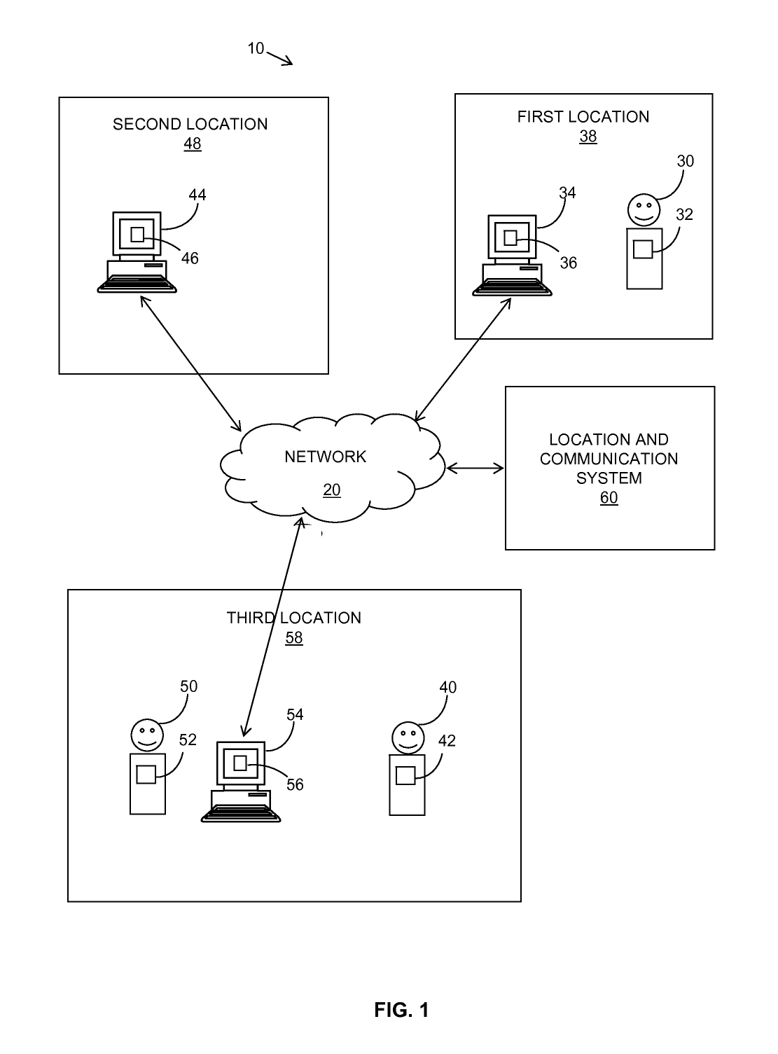

FIG. 1 shows a network environment 10. This network environment includes a network 20, a sending user 30, a receiving user 40, a proxy user 50, user devices 34, 44 and 54, and a location and communication system 60. The multiple user devices 34, 44 and 54 and the location and communication system 60 are configured to communicate with each other through the network 20. The network 20 can be the Internet, a local network, or other communications network. The network environment 10 also includes a first location 38, a second location 48 and a third location 58 that are all associated with a trade show event.

The sending user 30 has an event office location at the first location 38. The sending user 30 wears a badge which includes a unique RFID (Radio-frequency identification) tag 32 that can be tracked. The sending user 30 has a sending user device 34 that is able to communicate. The sending user device 34 can be a computer, personal digital assistant or other communication means. The sending user device 34 has an RFID reader 36 that can track RFID tags. The sending user device 34 also includes instant messaging capability.

The receiving user 40 has an event office location at the second location 48. The second location 48 is an area remote to the first location 38, for example, the second and first locations can be on opposite ends of a building. The receiving user 40 wears a badge which includes a unique RFID tag 42 that can be tracked. The receiving user 40 has a receiving user device 44 that is able to communicate. The receiving user device 44 can be a computer, personal digital assistant or other communication means. The receiving user 40 has left the second location 48 and is now at an event conference room at a third location 58. The receiving user 40 has left the receiving user device 44 at the second location 48. The receiving user device 44 has an RFID reader 46 that can track RFID tags and has instant messaging capability.

A proxy user 50 is in the event conference room at the third location 58. The third location 58 is an area remote to both the first and second locations. The proxy user 50 wears a badge which includes a unique RFID tag 52 that can be tracked. The proxy user 50 has a proxy user device 54 that is able to communicate. The proxy user device 54 can be a computer, personal digital assistant or other communication means. The proxy user device 54 has an RFID reader 56 that can track RFID tags and has instant messaging capability. The receiving user 40 is also in the event conference room at the third location 38 in a meeting with the proxy user 50. The receiving user 40 does not have the receiving user device 44, a phone or other means of communicating over the network 20.

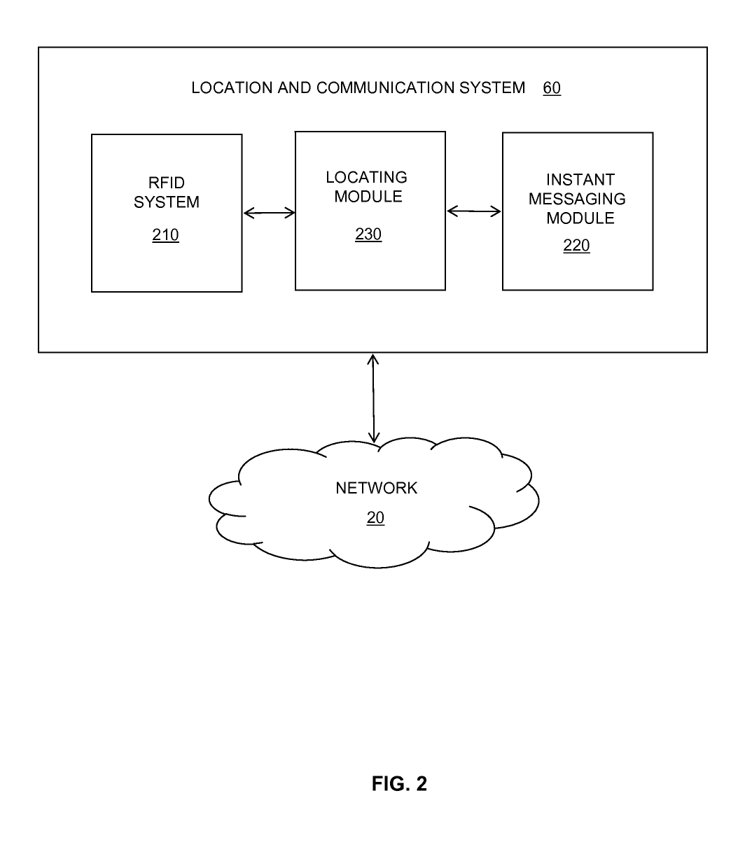

FIG. 2 shows an embodiment of the location and communication system 60 of FIG. 1. A locating module 230 communicates with an RFID system 210 and an instant messaging module 220. The locating module 230, RFID system 210 and IM module 220 can each be on a separate server or can all be integrated in one server. In an alternative embodiment, the locating module 230 can also communicate with a telephone system and/or an email module or other systems.

The RFID system 210 is a presence detection system which uses unique RFID tags and unique RFID readers that communicate using radio waves. The RFID system 210 is connected to the network 20 and can also be directly connected to the locating module 230. In one embodiment, every user wears a badge having a unique RFID tag attached. Alternatively, the RFID tags can be attached directly to clothing or another object. In this embodiment, all user devices include a unique RFID reader. When a user wearing badge/RFID tag is within a certain distance of a user device/RFID reader, the RFID system 210 identifies the user and tracks the location and movements of the user. Some RFID tags can be read from several meters away and beyond the line of sight of the RFID reader. RFID readers can also track more than one RFID tag at the same time. The RFID system 210 can be configured to track only in certain event buildings or certain areas of a building. In another embodiment, a GPS or other tracking system is used instead of the RFID system 210.

Instant messaging (IM) applications enable a form of real-time direct text-based communication between two or more people using computers or other devices. The user's text is conveyed over a network, such as the Internet. Instant messaging is based on clients that communicate with specified known users identified in a “Contact List”, “Friend List” or “Buddy List”. Typically, users communicate using instant messaging if they are currently “logged on” thus enabling real-time communication. For example, IBM® Sametime® is an instant messaging application. IM allows effective and efficient communication with immediate receipt of acknowledgment or reply. The instant messaging module 220 is connected to the network 20 and can also be connected to the locating module 230.

The network environment 10 helps users locate each other at a trade show event or other venue. For example, the first location 38 is a trade show booth, the second location 48 is a backroom trade show office for engineering, and the third location 58 is an event conference room for meetings. In this example, Sally from the sales department is assisting a premium customer with a problem in the booth area, but only Eric from engineering knows the answer to this customer problem. Eric was present at a computer in the backroom office but Eric has departed for a meeting in the event conference room without his computer and cell phone. Paul has a computer and is present in the event conference room with Eric. Sally, Eric and Paul are all employed by the same company and are wearing badges with unique RFID tags. Each of their computers includes an RFID reader and instant messaging capability. Sally is attempting to send an urgent instant message to Eric to obtain a quick answer to the customer question; however, Eric is not at his computer and is not responding to the instant messages or phone calls. Eric previously authorized the locating module 230 to track him while in the building at the trade show event. The locating module 230 has determined that Eric is not available for instant messaging communication and tracks Eric's location in the event conference room. The locating module 230 also identifies the group of people in Sally's social network. Next, the locating module 230 locates a computer, belonging to a user in Sally's social network, which is close to Eric. Specifically, the locating module 230 locates all the members in Sally's social network and identifies Paul as the closest member and subsequently, the locating module 230 sends an urgent instant message to Paul that asks Paul to tell Eric that Sally is urgently trying to contact him. Eric immediately contacts Sally and answers the customer question.

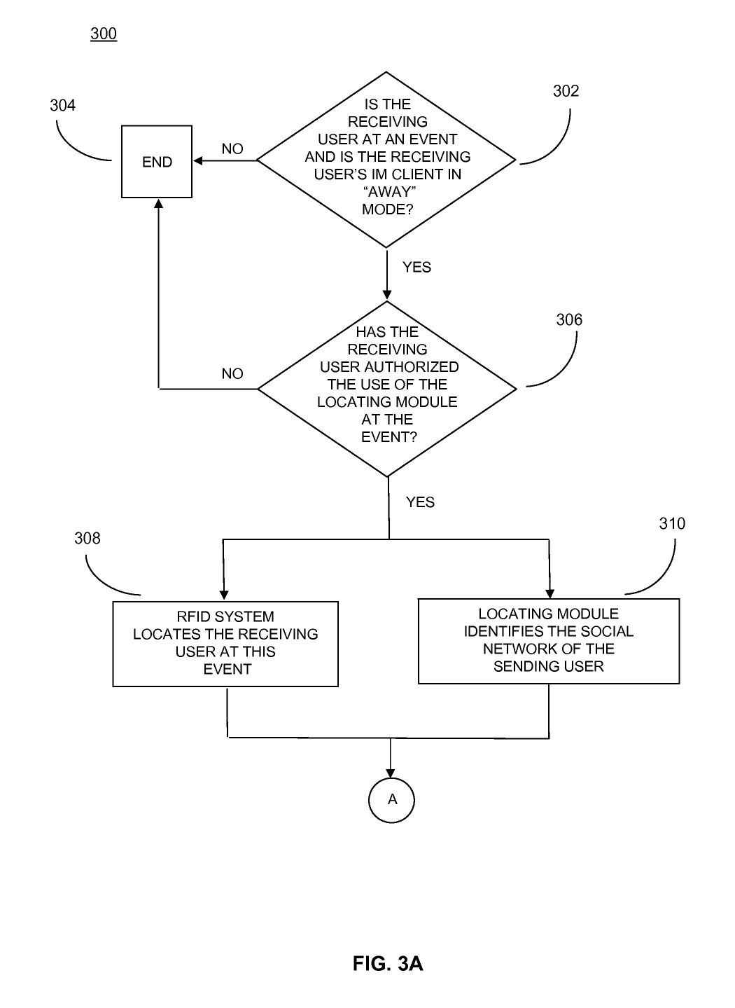

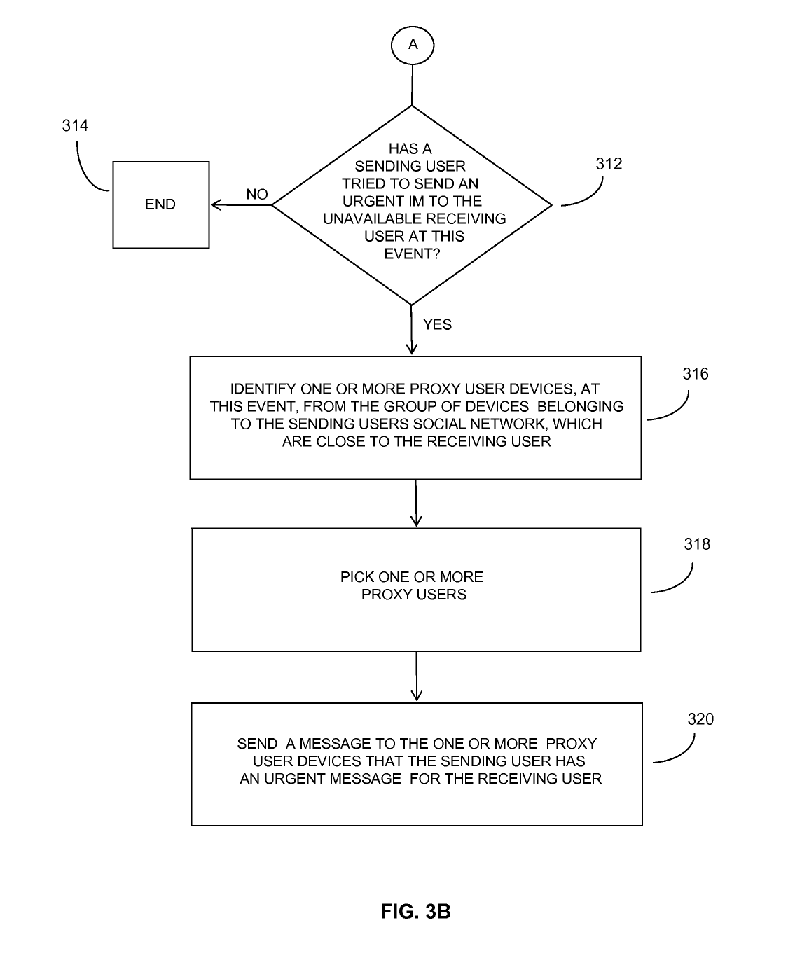

FIGS. 3A and 3B are a flowchart representation of a method 300 for contacting an unavailable user, who is at an event, through a proxy using instant messaging. Some or all of the method 300 can be performed on the location and communication system 60 described with reference to FIG. 1 and FIG. 2. This method 300 can pertain to one user or to multiple unavailable receiving users at the same time. Advantageously, the method 300 can reduce the time required to contact an unavailable instant messaging user.

According to the method 300, a determination is made as to whether or not a receiving user is at an event, and if the receiving user's IM client is in “away” mode (step 302) such that the receiving user 40 is unavailable for contact via instant messaging. Away mode can occur for various reasons, for example, in any of the following scenarios: if a user has not responded to a IM after a predetermined amount of time; if a user manually sets their IM client into an away mode or unavailable mode; if the IM client automatically puts the user into an away or unavailable type of mode; if the user's device is shut off; or if the user's device is automatically locked. When the IM client goes into away mode, and a determination is made that the receiving user is at an event, then the IM client informs the locating module 230 that the user is away. If the receiving user's IM client is not in away mode then the locating module 230 takes no further steps (step 304).

A determination is made if the receiving user 40 has authorized the use of the locating module 230 to track the receiving user 40 at this event (step 306). In this embodiment, to protect the privacy of the receiving user 40, neither the locating module 230 nor the RFID system 210 take any steps without prior approval from the receiving user 40 (step 304). Privacy concerns can be based on a desire not to be tracked and/or a desire to maintain a private social network. The receiving user 40 has the option of manually configuring the locating module 230 using a locating module menu option list, which can include, for example, locating module on/off, re-route instant messages on/off, etc. In another embodiment, the method 300 can skip step 306.

If the locating module 230 determines that the receiving user device 44 is in away mode; that the receiving user 40 is at an event; that the receiving user 40 has authorized the use of the locating module 230; then, the locating module 230 instructs the RFID system 210 to locate the receiving user 40 (step 308). The RFID system 210 finds the receiving user 40 by locating the unique RFID tag 42 worn by the receiving user 40. The RFID system 210 contacts the RFID readers at the last known location of the receiving user 40. If the receiving user 40 is not found, the RFID system 210 polls RFID readers nearby this last known location and increases the search radius until the receiving user 40 is found. After the receiving user 40 is found, the RFID system 210 continues to track the receiving user 40 while at this event. If the receiving user 40 is not found after a predetermined time, then the RFID system 210 can stop looking and continue looking again after a predetermined wait time. In an alternative embodiment, if the receiving user 40 is not found after a predetermined time, then the locating module 230 takes no further steps.

In one embodiment, the locating module 230 uses a heuristic tracking method to speed up the tracking process. Heuristic refers to experience-based techniques for problem solving, learning, and discovery. Heuristic methods are used to speed up the process of finding a satisfactory solution, where an exhaustive search for a better solution is impractical. The locating module 230 accomplishes this goal by monitoring and analyzing the movements of a user while at an event; then, using this data to identify a “likely location” where a user is more likely to be present at a specific time of the day. This is accomplished by the RFID system 210 periodically sending the users locations to the locating module 230 to store and analyze. For example, a user typically goes to lunch at 12:00 pm and returns at 1:00 pm or the user often takes a coffee break at 9:30 am. Thus, if it is 9:30 am and the user is on coffee break, the locating module 230 can determine how far the user is along on their route to the break room using heuristic methods to predict the user's next location. When instructed to locate a user, the RFID system 210 can first try to locate the user at the “likely location”. Heuristic methods assist the RFID system 210 to find users more quickly at events and/or other venues.

The locating module 230 identifies a social network of the sending user 30 (step 310). A social network is a list of individuals that a user has communicated with over a predetermined period of time. The user can specify one or more social network sources to be used. In an embodiment, the user selects from one or more of the following sources: a user's IM “Contact List”, “Friend List” or “Buddy List”; a user's contacts in an email application; a user's cell phone contacts; a user's “connections” on LinkedIn®; a users “friends” on Facebook®; or other social network sources. For example, the user can configure the locating module 230 to develop the user's social network only from the user's IM contacts. The locating module 230 can be configured to continually update a user's social network in real-time, or to only update the social network after the users IM client goes into away mode, or to update only at certain predetermined times. The locating module 230 can track the frequency of communications with each individual in the user's social network. The user does not need to personally know a contact. In other embodiments, the social network comprises the social network of the receiving user and/or the social networks of one or more other users.

A determination is made if a sending user has tried to send an urgent IM to the unavailable receiving user at this event, whose IM client is in “away” mode (step 312). The locating module 230 determines if the message is urgent. An IM message can be marked urgent by the sending user 30. Alternatively, the locating module 230 can query the sending user 30 if the message is urgent. If the message is not urgent, then the locating module 230 takes no further steps (step 314). If the message is urgent, then the locating module 230 will go to step 316. In one embodiment, the sending user 30 can configure the locating module preferences/options to only send conventional IMs and to not use the locating module 230, even if the receiving user's IM client is in away mode. In another embodiment, step 312 occurs before step 308 occurs. In another embodiment, even though the message received is not urgent, the locating module 230 proceeds to the next step 316.

The locating module 230 locates the one or more users at this event who are in the social network of the sending user 30 and are within a predetermined distance from the receiving user 40 (step 316). These one or more users are referred to as “proxy users” 50. Step 316 is accomplished by the locating module 230 instructing the RFID system 210 to determine which one or more RFID tags, that are associated with the users in the sending user's social network, are within a predetermined distance from the receiving user 40. In another embodiment, the proxy users can be chosen from the combined social networks of the sending user 30 and the receiving user 40.

If more than one proxy user 50 is identified in step 316, the locating module 230 chooses one or more proxy users (step 318). In one embodiment, the locating module 230 can be configured to automatically select a proxy user 50 based on one or more of the following criteria: select the proxy users with an IM client status of “available”; select the proxy user closest to the receiving user; select the two proxy users closest to the receiving user; select the proxy user with the highest frequency of communications with the sending user; or other various selection criteria.

The locating module 230 sends a message to the device of the one or more proxy users chosen in step 318 (step 320). This message can include the original message from the sending user 30 with a header stating that the message is urgent, or special, and asking the proxy user 50 to communicate the message to the receiving user 40. For example, “please deliver the attached message to Eric.” In another embodiment, the message does not include the original message and instead requests that the proxy user 50 informs the receiving user 40 that the sending user 30 is urgently trying to contact him. In this embodiment the message is an instant message. In other embodiments, the message can be an email message, phone message or any other type of communication. In another embodiment, the method 300 occurs at one or more other locations not related to an event.

The receiving user 40 can respond to the sending user 30 through the IM client of the proxy user device 54 and then be able to communicate further with the sending user 30. The receiving user 40 can also respond by email, phone or any other form of communication.

In one embodiment, the various users are displayed with their relative distances from each other shown. A display can show the receiving users location at an event in the middle of multiple concentric circles with each circle representing a different distance from the receiving user 40, and other nearby users identified by icons displayed in one or more of the circles. The display can highlight which of the nearby users are in the user's social network and/or which of the users are in available or away IM mode.

In another embodiment, a display shows where any user is located at any time. For example, if a manager and a user are both at an event and the user wants to send an instant message to his manager but does not want to disturb the manager if the manager is in a meeting; then, the user observes the event display to see if the manager is in an event meeting room. This capability can be restricted for privacy purposes; a person can at any time configure the system for any mode, for example, turn off my RFID tag, or only allow certain users to track me, or other modes. In another embodiment, the locating module 230 can map a user's location to an event map. The map can be a CAD drawing of a building, or a map of a complex or other location.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1-8. (canceled)

9. A computer program product for locating a user at an event, wherein the user has authorized being located at the event, the computer program product comprising:
a computer readable storage medium having computer readable program code embodied therewith, the computer readable program code comprising:
computer readable program code configured to track a radio frequency identification (RFID) tag of the user if the user is unavailable for instant messaging communication;
computer readable program code configured to receive an instant message communication directed to the user;
computer readable program code configured to determine that a second user has a predetermined relationship with a sender of the instant message and determining that a communication device of a second user detects the RFID tag of the user; and
computer readable program code configured to send a communication comprising a message for the user to the communication device of the second user.

10. (canceled)

11. The computer program product of claim 9 wherein computer readable program code is configured to track the RFID tag after the receipt of the instant message communication directed to the user.

12. The computer program product of claim 9 further comprising computer readable program code configured to access an instant message contact list of the sending user to determine the predetermined relationship with the second user.

13. The computer program product of claim 9 further comprising computer readable program code configured to access an electronic mail contact list of the sending user to determine the predetermined relationship with the second user.

14. The computer program product of claim 9 wherein computer readable program code is configured to graphically display an RFID tag of at least one of the users, to indicate a location of the at least one of the users.

15. The computer program product of claim 14 wherein computer readable program code is configured to graphically display the availability status of the communication device of the at least one user.

16. The computer program product of claim 9 wherein computer readable program code is configured to track wherein the tracking comprises a heuristic tracking.

17. A location and communication system for communication with an unavailable user at an event wherein the user has authorized being located at the event, comprising:
a radio frequency identification (RFID) system configured to track an RFID tag of the user if the user is unavailable for instant messaging communication;
an instant messaging module configured to provide instant messaging communication for a plurality of users through a communications network; and
a locating module in communication with the RFID system and the instant messaging module, the locating module configured to determine a second user having a predetermined relationship with a sender of an instant message;
wherein the RFID system is configured to determine that a communication device of the second user detects the RFID tag of the user and wherein the locating module is configured to send a communication intended for the user to the communication device of the second user in response to an instant message sent to the user.

18. A computer program product for locating a user, wherein the user has authorized being located at the event, the computer program product comprising:
a computer readable storage medium having computer readable program code embodied therewith, the computer readable program code comprising:
computer readable program code configured to track a radio frequency identification (RFID) tag of the user if the user is unavailable for instant messaging communication;
computer readable program code configured to receive an instant message communication directed to the user;
computer readable program code configured to determine that a second user has a predetermined relationship with a sender of the instant message and determining that a communication device of a second user detects the RFID tag of the user; and
computer readable program code configured to send a communication comprising a message for the user to the communication device of the second user.

19. (canceled)

20. The computer program product of claim 18 wherein computer readable program code is configured to track the RFID tag after the receipt of the instant message communication directed to the user.

21. The computer program product of claim 18 further comprising computer readable program code configured to access an instant message contact list of the sending user to determine the predetermined relationship with the second user.

22. The computer program product of claim 18 further comprising computer readable program code configured to access an electronic mail contact list of the sending user to determine the predetermined relationship with the second user.

23. The computer program product of claim 18 wherein computer readable program code is configured to graphically display an RFID tag of at least one of the users, to indicate a location of the at least one of the users.

24. The computer program product of claim 23 wherein computer readable program code is configured to graphically display the availability status of the communication device of the at least one user.

25. The computer program product of claim 18 wherein computer readable program code is configured to track wherein the tracking comprises a heuristic tracking.
